(19) United States
(12) Patent Application Publication
(10) Pub. No.: US 2003/0168880 A1
(43) Pub. Date: Sep. 11, 2003

(54) Sectional removably attachable top

(76) Inventors: James Thomas Burkel, Chelsea, MI (US); PETE NICK KIOUSIS, BIRMINGHAM, MI (US)

Correspondence Address: Pete Nick Kiousis, 1594 Sheffield, Birmingham, MI, 48009, US

(21) Appl. No.: 10/045,460

(22) Filed: Nov. 7, 2001

(51) Int. Cl. B60J 7/00

(52) U.S. Cl. 296/103

(57) ABSTRACT

A removably attachable top for vehicles. The top is preferably composed of five panels: one front top panel, one rear top panel, one rear side panel, one right side panel and one left side panel. When fully assembled, the top creates a rigid, weather-tight cover enclosing the driver, passenger, and cargo compartments. The individual panels of top are easily removably attachable to each other and to structural portions of the vehicle. The panels are also easily manageable during assembly and disassembly and storable, allowing the top to be selectively removed. The removable top may also be made using four panel or six or more panels.

### BACKGROUND OF THE INVENTION

1. Field of the Invention

The present invention relates to a removably attachable top for a vehicle having an open compartment such as a sport utility vehicle.

2. Background Art

Currently, removably attachable tops for vehicles such as sport utility vehicles fall into two categories based upon the materials out of which they are constructed. The first type of top is commonly known as a “soft top”. Soft tops are usually made from vinyl, canvas, or other pliable, cloth-like materials. Soft tops are also removably attachable to the motor vehicle, and are usually shaped in part by an internal frame that is also removably attachable to the motor vehicle and to the material out of which the top is manufactured. Soft tops are most often chosen by consumers because they are manageable by one person and, if necessary, the top, when removed, can be stored in the vehicle.

Unfortunately, soft tops suffer from a number of significant drawbacks. They are ineffective in reducing wind and road noise while the vehicle is moving. They offer little protection or insulation from extreme temperatures. They also add little to no structural integrity to the vehicle. Soft tops also offer no security against entry into the vehicle.

The second type of currently available top is commonly referred to as a “hard top”, and is usually made from wholly or in some combination of fiberglass, aluminum, steel, or any other hard, molded, fixed, or other rigid materials. Hard tops come in one and two piece versions. The two piece version usually has a removably attachable front top panel covering the front driver and passenger compartments of the vehicle. Both versions of the currently available hard tops discussed above are removably attachable to vehicles such as sport utility vehicles. A hard top is ordinarily selected by consumers instead of the soft top version because it offers a stronger, more secure, and weather-tight enclosure for the driver, passenger, and cargo compartments of the sport utility vehicle. However, both currently available versions of the hard top also suffer from significant drawbacks.

The major drawback of the one piece hard top is its awkward, cumbersome, and heavy design. It is virtually impossible for one person to remove the hard top unassisted, and removal usually requires the use of currently available mechanical devices, such as winches or hoists. Once removed, the one piece hard top requires a large amount of space for storage, as it is fragile when removed and standing apart from the vehicle and must therefore be stored carefully. The same is also true for the rear panel of the two piece hard ton.

### SUMMARY OF THE INVENTION

The objective of the invention is to create a removably attachable, rigid top for sport utility vehicles that is composed of multiple, integrated panels that are easily attachable, handable, removable, and storable by one person.

Another object of the invention is to produce a removable top that reduces wind noise and provides better insulation against the environments.

The removably attachable top of the present invention comprises a plurality of separate, removably attachable panels, each of which has four principal edges. Preferably, the removably top comprises five separate pieces though it could be designed having fewer or more separate panels. When properly assembled, the panels form a rigid, removably attachable top that covers and encloses the driver, passenger, and cargo compartments of the vehicle. Once assembled, the top may be removed completely either in one piece (fully assembled) or panel by panel. In addition, one or mor panels may be removed such as the front top panel leaving the remaining panels assembled. The could completely expose the open compartment or just cover a portion of the open compartment. This variation on the assembly allows the occupants limited exposure to elements without removing the entire top.

As mentioned, the top described herein is composed of multiple, integrated panels, making assembly and disassembly logical and easy. The first panel is a side panel. The second panel is a second and opposite side panel. Each side panel has top, bottom, front, and rear edges. The bottom edges of the first and second side panels of the invention are removably attachable to the corresponding first and second side structural portions of the sport utility vehicle. Further, the two front edges of the two side panels are designed to create a barrier with the rear edges of the corresponding doors (factory installed or after-market) of the vehicle to minimize wind and road noise and protect the occupants from the elements,

The third panel of the invention is a rear side panel. The rear side panel of the invention has top, bottom, and two side edge. The bottom edge of the rear side panel of the invention is removably attachable to the rear structural portion of the vehicle. The side edges of the left side panel of the invention are removable attachable to the corresponding adjacent rear side edges of the two opposite side panels of the invention.

The fourth panel of the invention is a front top panel. The front top panel of the invention has front, rear, and two side edges. The front edge of the front top panel of the invention is removably attachable to the front structural member of the sport utility vehicle. This front structural member is ordinarily part of the windshield portion of the vehicle. The side edges of the front top panel are also designed to create a barrier with the top edges of the corresponding doors (factory installed or after-market) of the vehicle to minimize road noise and protect the occupants from the elements. In addition, sections of the side edges of the front top panel of the invention may also be removably attachable to sections of the corresponding adjacent top edges of the two opposite side panels of the invention

The fifth panel of the invention is a rear top panel. The rear top panel of the invention has front, rear, and two side edges. The rear edge of the rear top panel of the invention is removably attachable to the adjacent top edge of the rear side panel of the invention. The side edges of the rear top panel of the invention are removably attachable to the corresponding adjacent top edges of the two opposite side panels of the invention. The front edge of the rear top panel of the invention is removably attachable to the adjacent rear edge of the front top panel of the invention. When assembled properly, the two top panels form a weather-tight barrier for the driver, passenger, and cargo compartments of the vehicle.

In addition to the four edges described above, the five panels may, as design requires, also have any of the following: flanges, catches for clamps, camp assemblies, holes, integrated screws, nuts, and/or washers, projections, cooperating or non-cooperating steps, flat portions, flaps, windows, corrugations, dovetails, bores, and grooves. As technology permits or design requires, the panels may also have additional characteristics.

A second embodiment of the invention comprises four separate removably attachable panels wherein the [symbol] a single panel.

When fully assembled, the panels of the four panel, five panel, or other multiple panel removable tops of the present invention form a rigid, weather-tight, and removably attachable top for a vehicle enclosing the driver, passenger, and cargo compartments of the vehicle that may be removed in one piece, or panel by panel. The front top panel of a top having five panels may also be removed without removing the remaining four panels, creating an open air area in the front driver, passenger, and cargo compartments while keeping the rear passenger and cargo compartments of the vehicle enclosed. Both top panels of a top having five panels or the top panel of a four panel top may be removed leaving only the side panels.

The removably attachable top described herein offers the protection, security, and quiet of currently available removably attachable one and two piece hard tops, but is designed to be assembled, disassembled, and stored much more easily than either currently available removably attachable hard or soft tops, allowing the driver or passenger(s) to remove the top before or during a trip, and allowing the driver or passenger(s) to enjoy exposure to the elements as desired, The combination of the strengths of the multi-panel, removably attachable top described herein with the ease of removal and storage made possible by its design makes the invention a desirable top for vehicles, allowing the driver or passenger(s) the freedom to remove and store the top at almost any point during a journey with little time or difficulty.

### BRIEF DESCRIPTION OF THE DRAWINGS

FIG. 1 is a perspective view of the removable top of the present invention on a vehicle;

FIG. 2a is a sectional view showing one method of attaching a side panel to the vehicle;

FIG. 2b is a sectional view showing a second method of attaching a side panel to the vehicle;

FIG. 2c is a sectional view showing a third method of attaching a side panel to the vehicle;

FIG. 2d is a sectional view showing a fourth method of attaching a side panel to the vehicle;

FIG. 3 is a sectional view showing one method of attaching a rear panel to the vehicle;

FIG. 4a is a perspective view showing the rear side panel connected to the side panel;

FIG. 4b is an exploded view of the attachment of FIG. 4a;

FIG. 4c is en exploded view of two other methods of attaching the rear panel to the side panel;

FIG. 4d is a sectional view of another method of attaching the side panel to the rear panel;

FIG. 5a is a sectional view showing one method of attaching the top panel to the side panel;

FIG. 5b is a sectional view showing a second method of attaching the top panel to the side panel;

FIG. 5c is a sectional view showing a third method of attaching the top panel to the side panel;

FIG. 5d is a sectional view showing a fourth method of attaching the top panel to the side panel;

FIG. 6a is a sectional view showing a method of attaching the top panel to the rear panel;

FIG. 6b is a sectioned view showing a second method of attaching the panel to the rear panel;

FIG. 7 is a sectional view showing one method of attaching the top front panel to the vehicle and to the top rear panel;

FIG. 7a is sectional view of showing a second method of attaching the top front panel to the top rear panel;

FIG. 8 is a side sectional view of a second embodiment of the present invention; and

FIG. 9 is an exploded view of the removable top of the present invention.

### DETAILED DESCRIPTION OF THE PREFERRED EMBODIMENT(S)

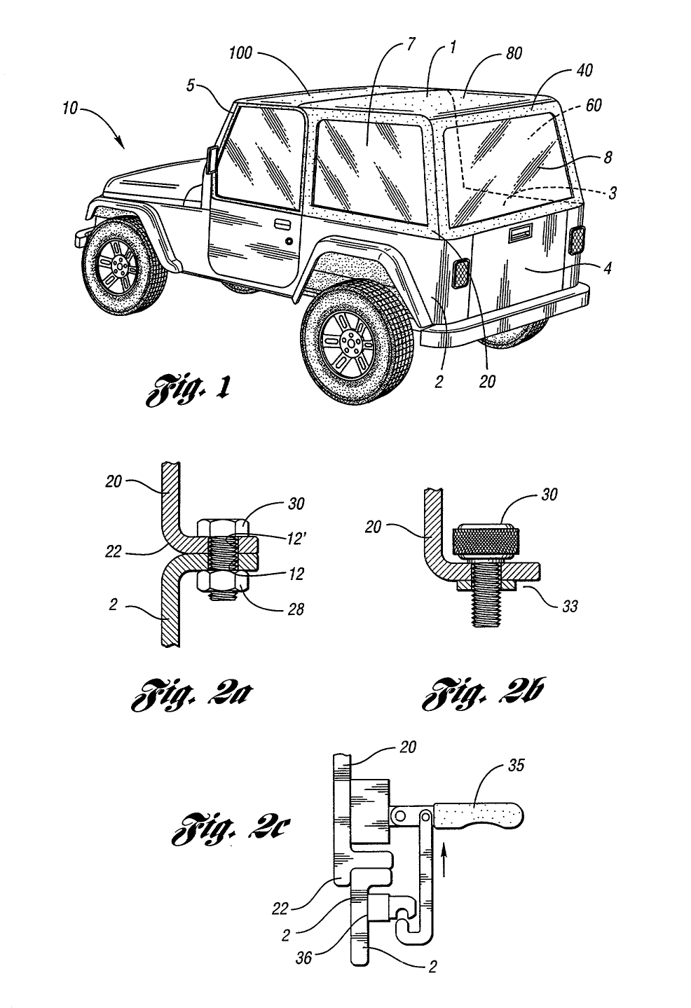

Referring now to FIG. 1, the removable top 1 of the present invention is shown fully assembled on top of a vehicle 10. The vehicle may be any vehicle having an open compartment such as an Isuzu Amigo®, a Suzuki Sidekick®, a Daimler-Chrysler Jeep®, or an AM General Hummer® Open Top vehicle. The invention can also be modified to accommodate pick-up trucks, sport utility vehicles (SUV's), convertibles, and drophead-type coupes. FIG. 9 illustrates the removable top 1 of the present invention in an exploded view.

Vehicle 10 has first side structural vehicle portion 2, second side structural vehicle portion 3, at least one rear side structural vehicle portion 4, and front structural vehicle member 5 which is generally the front windshield frame. The rear side structural portion 4 may be a single portion, or, as is more frequently the case, comprise multiple subportions, two subportions formed when each of the side structural vehicle portions wrap at least partially around to the rear of the vehicle. The scope of the invention is not affected by having one or more rear portions. For simplification, the disclosure will merely refer to one rear side structural portion.

The preferred embodiment of the removable top comprises five separate removably attachable panels—a first side panel 20, a rear side panel 40, a second side panel 60, a rear top panel 80, and a front top panel 100. For simplification, this disclosure commonly refers to just one side panel attachment but the invention often requires a similar attachment for the other side panel. An alternate embodiment of the removable top 1 containing four panels is discussed below.

Preferably, the panels will be molded using fiberglass or injection molded out of a polymer such as ABS (acrylonitrile-butadiene-styrene), TPO (thermoplastic olefin), or TPU (thermoplastic urethane). The panels may also be made out of other composite materials, a metal, or other materials. The manufacturing of the panels will depend on the material. The panels 20, 40, 60 may have windows 7 as shown in FIG. 1 to allow the vehicle occupants to see outside of the vehicle. The windows 7 may be made out of glass, clear plastic, or other materials. Further, the windows 7 may be manufactured concurrently with the panels or may be added to the panels late. A liftgate structure 8 may also be included on the rear panel 40. The windows 7 or liftgate 8 may contain windshield wiper blades and a rear defroster/defogger. Top panels 80 and 100 may also have windows, moonroofs, or sunroofs (not shown).

Combined, the panels 20, 40, 60, 80, and 100 replace a commercially available conventional hard or soft top or in some cases may add a top where one previously did not exist. Therefore, the removable top should preferably attach to the vehicle in a manner similar to a commercially available hard top. However, the top 1 and/or the vehicle 10 may be modified to ensure a proper fit. For example, older vehicles may have different attachment points than the current production vehicles. Clamps, catches, bores, integral nuts, and/or other components may need to be added to either the panels or the vehicle structural portions. A current hard top is attached to a vehicle using nuts and bolts at a number of locations along each of the vehicle side panels and additional locations along the rear panel. The front of a current hard top is attached to a vehicle member, the front windshield frame, using two clamps.

However, the removable top 1 of the preset invention may be attached to a vehicle 10 using other attachment points and/or methods without deviating from the scope of this invention.

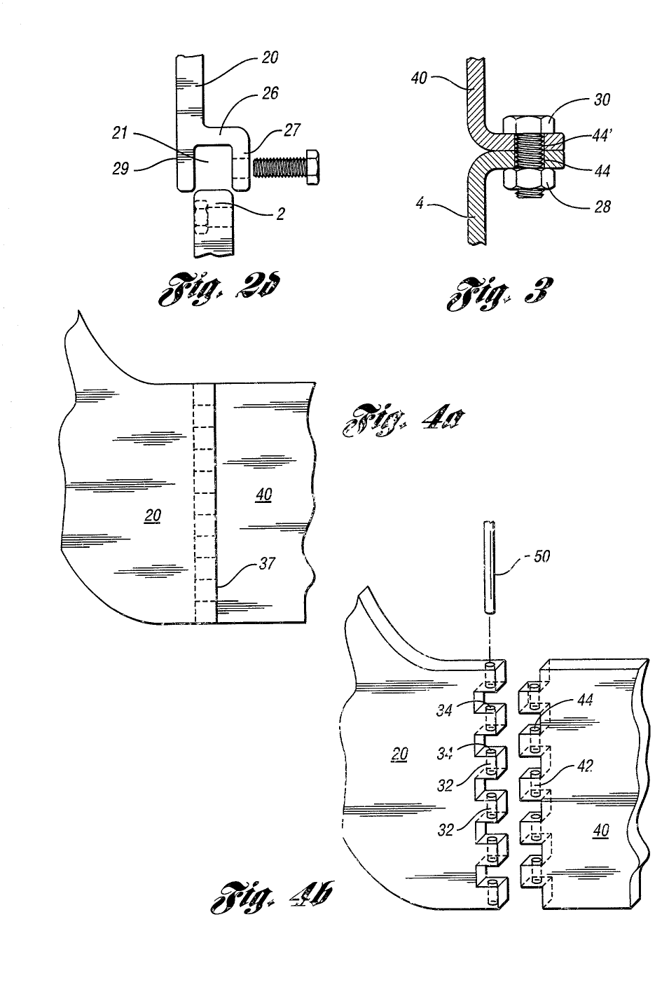

The removable top 1 can be assembled onto a vehicle in several ways. However, the preferred assembly method is to first attach side panel 20 to the vehicle. In one attachment method, as shown in FIG. 2a, first side panel 20 having holes 12′ is placed over first side structural vehicle portion 2 with holes 12 such that holes 12 and 12′ are aligned. Reaching inside the vehicle, a screw or bolt 30 is placed through holes 12 and 12′ and tightened using nut 28. For example purposes only, on a current vehicle, there are at least four holes. Fewer or more attachment points can be used depending on for example if the top 1 is a replacement top and the size/weight of the panels. The first side panel 20 is now self supporting. The bottom edge 22 of the first side panel 20 can either be a radius, as shown in FIG. 2a, or it can extend further downward, as shown in FIG. 2c. By extending the edge 22 even farther, it can be used to further stabilize the side panel while it is self supporting. The nut 28 can also be made integral to the vehicle body to simplify assembly of the panel to the vehicle. Conversely, the nut 28 may be made integral to the panel and the bolt 30 may be inserted from below.

The assembly process can be [symbol] by using an ergonomically designed, hand-turnable bolt 30 having a [symbol] washer 33 so that the belt 30 is semi-permanently attached to the panel 20 as shown in FIG. 2b.

In FIG. 2c, an alternative method of assembling the side panel 20 to side vehicle structural portion 2, is shown using a clamp 35. Clamp 35 can be a mechanical toggle requiring a catch 36, as shown, or any other clamping devices A “catch” or hook may need to be added to the structural portions of the vehicle for full and proper use of the clamp 35. One skilled in the art could devise a clamp or panel structure such that a catch is not required. Alternatively, the clamp 35 can be placed on the vehicle structural portion to catch the panel.

A third method of attaching the side panel 20 to side vehicle structural portion 2 is shown in FIG. 2d. Side panel 20 has proximate its bottom edge 29 an inwardly facing flange 26. A flange 27 extends downwardly from the inwardly facing flange 26 forming a channel 21. The dimensions of flanges 26 and 27, and therefore channel 21, are designed such that channel 21 fits over the top of side vehicle structural portion 2. The side panel 20 can be further secured to the side vehicle structural portion 2 using nuts and bolts through either flanges 26 (not shown) or 27 and side vehicle structural portion 2. A nut may be made integral to the side vehicular portion.

Alternatively or supplementally, the panels may be attached to the vehicle using any other suitable methods, such as magnets, electromagnets, hook and loop type fasteners, adhesives, or other methods.

According to one method of assembling the removable top 1, the rear side panel 40 is then attached to rear vehicle structural portion 4. Preferably, rear side panel 40 is [symbol] in any manner previously described for the attachment of panel 20. As shown in FIG. 3, holes 44 in rear side panel 40 and holes 44′ in rear vehicle [symbol] portion 4 are aligned and a bolt 30 is installed therethrough. One or more [symbol] points may be needed. Rear side panel 40 may have a liftgate 8 that can be opened to make it easier to attach rear side panel 40 to the rear side structural [symbol] 4 of the vehicle. Rear side panel 40 may also be attached using any other method described above.

Next, second side panel 60 is attached to second side structural vehicle portion [symbol] methods described above. However, the side panel 60 may be attached [symbol] vehicle before the [symbol] panel 40 is attached.

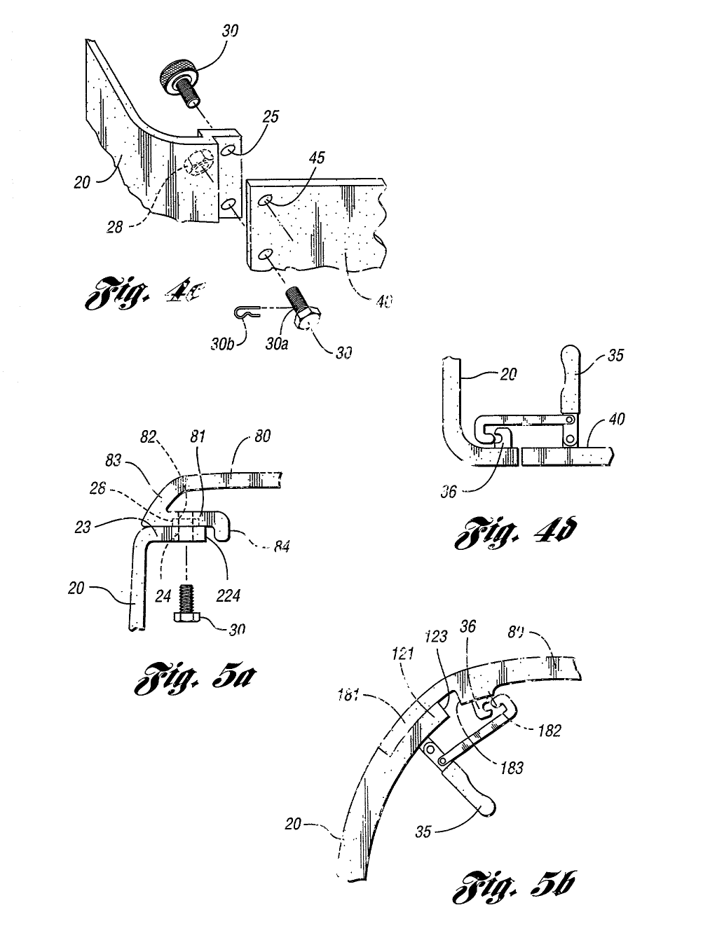

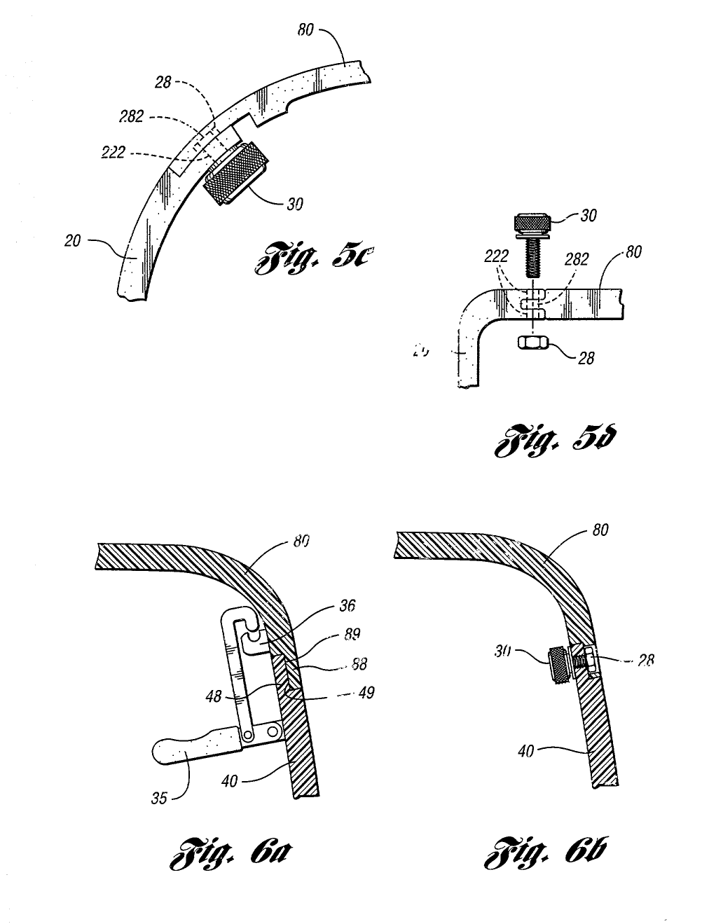

For extra rigidity, rear side panel 40 may be attached to side panels 20 and 60. Three different methods of attachment are illustrated in FIGS. 4a (and 4b), 4c, and 4d. As shown in FIG. 4a and 4b, side panel 20 or 60 can have a corrugated structure having projections 32. A bore 34 extends through each projection 32. Rear side panel 40 may also have a complementary corrugated structure having projections 42 each with bores 44 therein. Side panel 20 or 60 is then matched with rear panel 40. A dowel 50 is then inserted through bores 34 and 44 to secure the side panel 20 or 60 to rear panel 40. As shown in FIG. 4a, flap 37 may extend from either the exterior surface of side panel 20 or 60 or the exterior surface of rear panel 40 to cover the corrugated structure and make it appear as if it is a straight line. Additionally, or in the alternative, a flap may extend from the interior surface of either side panel 20 or 60 or rear panel 40 to cover the corrugated appearance from the interior.

FIG. 4c illustrates another method of attaching the side panels 20 and 60 to the rear side panel 40. In this figure, rear panel 40 and side panel 20 contain horizontal bores therein, 45 and 25 respectively, which are in alignment when the panels are properly assembled. A bolt 30 is inserted through the holes from either direction and secured with a nut 28. A securing means, such as a pin 30b, may be inserted through bore 30a on the bolt 30 to prevent tampering. The pin 30b, may be inserted from inside the vehicle to secure the bolt 30 without the need for a nut to further simplify the assembly process. Either panel may be contoured to provide a more flush surface. Further, the bolt 30 or the [symbol] 28 may be affixed or molded integrally to either panel to make assembly [symbol] . Also, either bore 45 or 25 may be simply threaded so that no additional [symbol] is needed. As previously described, the bolt 30 may be an ergonomically designed, hand-turnable bolt.

FIG. 4d shows another method of attaching side panel 20 to the rear side panel 40 using a clamp 35 and catch 36 as described above.

The preferred embodiment of the removable top 3 comprises two top panels 80 and 100. The suggested next assembly step for this preferred embodiment involves attaching the rear top panel 80 to the side and rear panels 20, 40 and 60. By attaching the rear top panel before the front top panel 100, the removable top 1 can perform like a Targa-type top having an open front portion over the driver. If a Targa-type assembly is preferred, the side and rear panels 20, 40, and 60 can be sufficiently secured to the corresponding vehicle structural portions of the vehicle, to each other, and to the top rear pane 30 as described below, such that no other points of attachment are necessary to secured attach the Targa-type [symbol] to the vehicle.

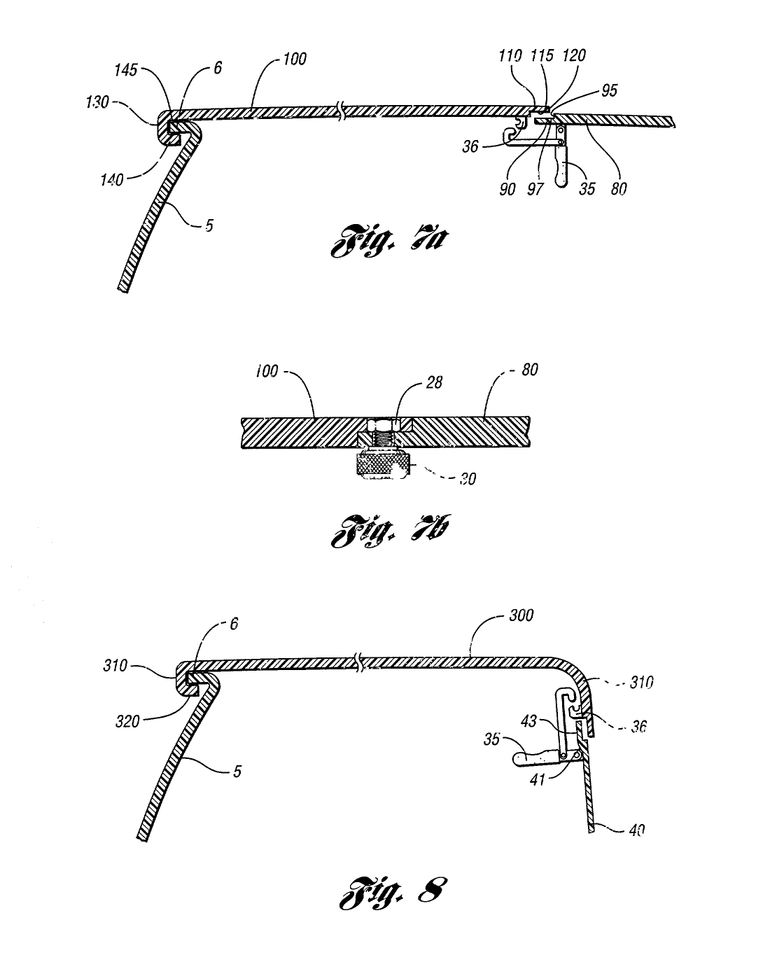

Rear top panel 80 car be attached to the side panels by a variety of methods. Four different methods are illustrated in FIGS. 5a-5d, though the invention is not limited to the methods shown.

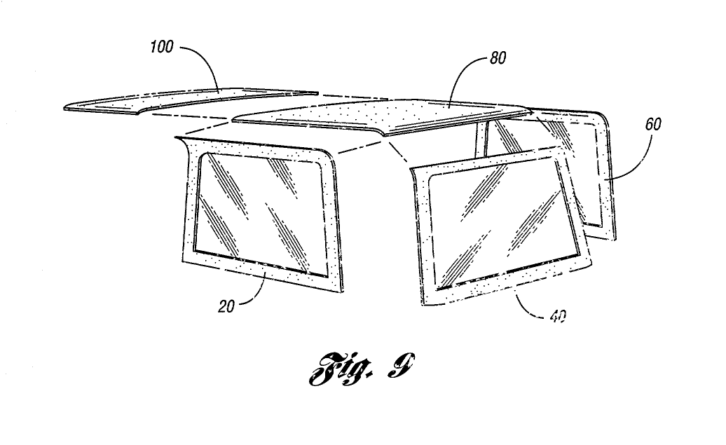

The first method is shown in FIG. 5a. Side panel 20 comprises a flat portion 23 extending towards the interior of the vehicle. The flat portion 23 is shown as horizontal, though it may be angled either up or down. Bore 24 extends through flat portion 23. Rear top panel 80 comprises a downward extending portion 83 and an inward facing flat portion 81. The angle of the inward facing flat portion 81 is designed to match the flat portion 23. Inward facing flat portion 81 has a bore 82 therein which aligns with the bore 24 and causes downward extending portion 83 to align with side panel 20. The top rear panel 80 is then placed on top of the side panels 20 and 60 from the rear of the vehicle and pushed forward until the end of the top rear panel 80 aligns with the rear panel 40 s shown in FIGS. 6a and 6b). When in proper position, a bolt 30 is pushed through aligned bores 82 and 24 and secured with a nut 28. To make assembly easier, nut 28 cap be made integral with inward facing flat portion 81 and bolt 30 can be a hand-turnable bolt semi-permanently attached to the side panel 20. Or, as previously described, bore 82 may simply be threaded to negate any need for an additional part. Further, to help align the panels 20 and 80, inwards facing flat portion 81 may have a downstanding flange 84 to abut or otherwise co-operate with the inside edge 224 of flat portion 23. The gap between downstanding flange 84 and inside edge 224 will depend on specific manufacturing and design criterion.

FIG. 5b illustrates using a clamp 35 and catch 36 to attach the components. Side panel 20 comprises a top portion 121 that may taper slightly and end with surface 123. Top rear panel 80 comprises an end portion 181 that may taper slightly and a stopping block 182 having an outside surface [symbol] FIG. 5b illustrates the union of the two panels taking place at approximately or radius created by the two panels, though the union may take place on the remo [symbol] top 1 or even on the top portion of the removable top 1. End portion 181 ov [symbol] portion 121 and therefore, the portions 181 and 121 may be tapered and/or stepped (as shown) to create a better appearance. The outside facing surface 183 may co-operate vito surface 123 to ease assembly as described with FIG. 5a. Clamp 35 and catch 36 may be used to secure side panel 20 to the top rear panel 80.

Fig. 5c illustrates another attachment method wherein the side and top rear panels 20 and 80 are similar to those described in FIG. 5b except that at least one nut 28 and bolt 30 is used to attach the panels together through bores 222 and 282 in side and top rear panels respectively. The nuts and bolts may be inserted from either side and securing means may also be used. Preferably, the nut 28 is integral to top rear panel 80 and the bolt 30 is semi-permanently attached to side panel 20.

Lastly, a tongue and groove assembly method may be used as shown in FIG. 5d. In this illustration, the tongue is shown on the top rear panel 80 and the groove is shown on the side panel 20 though it is possible to reverse the location of the tongue and grove. The panels may be attached using either a dowel (not shown) or a nut 28 and bolt 30 through bores 282 and 222 of the top rear panel 80 and side panel 20 respectively [symbol] means may also be used.

Preferably, top rear [symbol] rear side panel 40. FIG 6a shows one example [symbol] rear panel 40. Clamp 35 and [symbol] may be used clamp the [symbol] panels 40 and 80 together. However, it is preferred to have co-operating step 88, [symbol] forward [symbol] surface 89, and co-operating step 68, with rearward facing surface 49, in top rear panel 80 and rear panel 40, respectively, to add extra support and assist with alignment. In operation, the top rear panel 80 is placed [symbol] of side panels 20 and 60 and [symbol] forward until surface 89 abuts surface 49. [symbol] , the top rear panel 80 and the rear panel 40 may be attached using other [symbol] For example, an integrally molded nut 28 and a hand-turnable, semi- [symbol] attached bolt 30 may be used as shown in FIG. 6b.

Referring now to FIG. 7 [symbol] , are last step in attaching the preferred embodiment is to attach the front top panel [symbol] to the vehicle 10 and to the top rear panel 80. The front structural member 5 of a vehicle generally is the windshied frame, through for other embodiments, it may be another vehicle structural portion. A vehicle 10 may have a forward facing flange 6 which is used to secure the vehicle's soft and/or hard tops. The top front panel 100 has a downward flange 130 at the front end of the panel and a rearward facing flange 140 extending back from the downward flange 130. The flanges 130 and 140 define a groove 145. Different vehicles may have different structure and therefore requires a different method to attach the top front panel 100 to the vehicle 10. Clamps, nuts and bolts, and other methods may be used.

Preferably, a flange 110 having a rear surface 120 and a bottom surface 115 extends for the rear of top rear panel 100. Further, a flange 90 having a top surface 97 and a forward facing surface 95 [symbol] from top rear panel 80.

To install the front top panel 100 [symbol] vehicle having a front structural member, the top front panel 100 is [symbol] the forward facing flange 6 of front structural member 5 is in the [symbol] / either rotated or otherwise positioned such that the rear surface [symbol] or [symbol] , the forward facing surface 95 of rear top panel 83 and bottom surface 113 rests on top of top surface 97. Of course, one skilled in the art could devise other methods of attaching the top panel together.

Various gaskets and water tight [symbol] , such as those discussed in U.S. Pat. No. 6,203,100, may be used to prevent water from entering the vehicle.

Preferably, the front top panel 100 will be attached to the front structural member 5 using a clamp [symbol] available on certain models of the current Jeep® vehicle. Also, the front top panel 100 may be attached to the top rear panel 80 using a clamp 35 (as shown), or other known means, such as a nut and bolt.

FIG. 7b shows an alternative method of attaching front top panel 100 to rear top panel 80 using an ergonomic, hand-turnable, semi-permanently attached bolt 30 and an integrally molded nut 28.

FIG. 8 illustrates the second embodiment of the removable top 1 comprising four panels. In this embodiment, the top panel comprises a single panel 300. Side panels 20, 40, and 60 may remain the same. The front of panel 300 may comprise downstanding flange 310 and rearwardly facing flange 320 and attaches to the vehicle in any manner previously discussed. The top panel 300 may removably attach to the side panels 20 and 60 and rear panel 80 in any manner discussed above.

In addition to the Targa-style top, the removable top of the present invention can be installed on a vehicle 10 using only side panels 20, 40, and 60 to create a more open top. The side panels 20, 40, and 63 can be attached to the vehicle 10 and/or each other sufficiently to allow the vehicle to be driven.

The multi-panel, removably attachable top 1 described herein combines the strengths, while minimizing the weaknesses, of all types of currently available removably attachable hard and soft tops for vehicles having open compartments. When fully assembled, the invention substantially reduces wind, road, and other vehicular noise while the vehicle is moving, offering a quieter ride than vehicles outfitted with currently available soft tops. The invention insulates passengers and cargo from the elements, including extreme temperatures. The invention also offers security to the driver, passengers, and cargo compartments of the vehicle not possible in models having currently available soft tops.

Most significantly, the invention is easily removable and equally easily storable. Because the invention is composed of multiple integrated panels, all of which are removably attachable to each other and to structural portions of the vehicle, the entire top (panel by panel, can be removed quickly and easily by one person. Once removed, the panels, being virtually flat and smaller in size than the 1-piece and 2-piece hard tops, are easily storable in a much smaller area than that required by currently available one and two piece hard tops, and may be designed to fit within the cargo compartments and/or portions of the passenger compartments of the vehicle. The panels can also be designed to stack on top of each other thereby requiring less storage space. The panels may be essentially flat having minimal curves and edges making stacking easier. The curved edges could be alternated such that the height of the five stacked panels will be essentially the height of the five thicknesses. The length on width of the stack will essentially be the length and width of the largest panel.

The removably attachable top 1 described herein, composed of integrated panels removably attachable to each other and to structural portions of the vehicle, is designed to maximize all advantages and minimize all disadvantages of currently available removably attachable soft and hard tops by creating a rigid, secure, and weather-tight enclosure for the driver, passenger, and cargo compartments of the vehicle and offer ease of removal and storage not possible with currently available removably attachable tops.

The removable top 1 can also be simply modified to be applied to pick-up trucks to cover the truck bed. Such a removable top comprises at least one side panel for each side, a rear panel, at least one top panel, and a front panel that may attach to the front of the side panels and the front of the forward most top panel. The forward panel may also be attachable to the vehicle. Depending on the size of the truck bed to be covered, the side panels and the top panel may be more than a single piece. This would facilitate easier storage in the vehicle. As with the other embodiments, this removable top may be easily removed, assembled, stored and stacked to minimize storage space. The height of the panels could vary depending on the specific need. Short side panel heights could provide storage while taller side panels could allow someone to stand upright in the truck bed. Additionally, some vehicles may comprise side panels but no roof. Accordingly, the present invention can be modified to only include one or more top panels that may attach to one or more of the vehicle front structural member, the vehicle side panels, or to each other. A rear side panel may also be included.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A removable top for an automotive vehicle, the vehicle having a first side structural portion of the vehicle, a second side structural portion of the vehicle, at least one rear side structural portion of the vehicle, and a front structural vehicular member, the removable top comprising:
a first side panel having an upper edge, a lower edge, a front edge, and a rear edge;
a rear side panel having an upper edge, a lower edge, a first side edge, and a second side edge;
a second side panel having an upper edge, a lower edge, a front edge, and a rear edge;
a rear top panel having a front edge, a rear edge, a first side edge, and a second side edge; and
a front top panel having a front edge, a rear edge, a first side edge, and a second side edge.

2. The removable top of claim 1 wherein the lower edge of the first side panel is removably attachable to the first side structural portion of the vehicle of the vehicle; the lower edge of the rear side panel is removably attachable to the rear side structural portion of the vehicle of the vehicle; and the lower edge of the second panel is removably attachable to the second side structural portion of the vehicle of the vehicle.

3. The removable top of claim 1 wherein the front edge of the front top panel is removably attachable to the front structural vehicular member.

4. The removable top of claim 1 wherein the rear edge of the front top panel is removably attachable to the front edge of the rear top panel.

5. The removable top of claim 1 wherein the rear edge of the rear top panel is removably attachable to the top edge of the rear side panel and the side edges of the rear top panel are removably attachable to the top edges of the first and second side panels.

6. The removable top of claim 1 wherein the rear edge of the first side panel is removably attachable to the corresponding first side edge of the rear side panel and the rear edge of the second side panel is removably attachable to the corresponding second side edge of the rear side panel.

7. The removable top of claim 1 wherein the bottom edges of the side panels have bores therein to removably attach the side panels to the vehicle.

8. The removable top of claim 7 wherein the rear side panel has at least one bore therein to removably attach the rear side panel to the vehicle.

9. The removable top of claim 5 wherein the rear edges of the side panels have corrugated structure having projections with bores extending therethrough, and side edges of the rear side panel have a complementary corrugated structure having projections with bores extending therethrough, and wherein the removable top further includes a dowel that can be inserted through the bores to secure the side panels to the rear panel.

10. The removable top of claim 1 wherein the first and second side panels are connected to the rear side panel using a clamp.

11. The removable top of claim 1 wherein the first and second side panels have bored therein and the rear side panel has bores therein which align with the bores in the first and second side panels.

12. The removable top of claim 1 wherein the rear top panel is attached to the first and second side panels with a clamp.

13. The removable top of claim 1 wherein the rear top panel has bores therein and the first and second side panels have bores therein which align with the bores in the first and second side panels.

14. The removable top of claim 1 wherein the top rear panel has a top and bottom surface and further comprises a forward lip that extends forward from the bottom surface.

15. The removable top of claim 14 wherein the top front panel rests on top of the forward lip of the top rear panel.

16. The removable top of claim 1 wherein the top front panel is removably attached to the top rear panel by means of a clamp.

17. The removable top of claim [symbol] wherein the panels are configured to be stackable.

18. The removable top of claim 11 further comprising nuts having a throughbore for insertion into the bores in the panels for securing the panels and a pin for insertion into the throughbore of the bolt for securing the bolt.

19. The removable top of claim 10 wherein the side edges of the top panel are removably attachable to the top edges of the side panel.

20. A removable top for an automotive vehicle, the vehicle having a first side structural portion of the vehicle, a second side structural portion of the vehicle, at least one rear side structural portion of the vehicle, and a front structural vehicular member, the removable top comprising:
a first side panel having an upper edge, a lower edge, a front edge, and a rear edge;
a rear panel having an upper edge, a lower edge, a first side edge, and a second side edge;
a second side panel having an upper edge, a lower edge, a front edge, and a rear edge; and
a top panel having a front edge, a rear edge, a first edge, and a second side edge.

21. The removable top of claim 20 wherein the lower edge of the first side panel is removably attachable to the first side structural portion of the vehicle of the vehicle; the lower edge of the rear side panel is removably attachable to the rear side structural portion of the vehicle; and the lower edge of the second side panel is removably attachable to the second side structural portion of the vehicle of the vehicle.

22. The removable top of claim 20 wherein the front edge of the top panel is removably attachable to the front structured vehicular member.

23. The removable top of claim 20 wherein the rear edge of the first side panel is removably attachable to the corresponding first side edge of the rear side panel and the rear edge of the second side panel is removably attachable to the corresponding second side edge of the rear side panel.

24. The removable top of claim 20 wherein the rear section of the top panel is removably attachable to the top edge of the rear side panel.

25. A top for an automotive vehicle having an open compartment comprising:
a first side panel having a bottom edge, a top edge, and a rear edge;
a rear panel having a bottom edge, a first side edge being removably attachable to the first side panel, a top edge, and a second side edge;
a second side panel having a bottom edge, a top edge, and a rear edge being removably attachable to the second side edge of the rear panel, and
a top panel having side edges being removably attachable to the top edges of first and second side panels and a rear edge being removably attachable to the top edge of the rear panel.

26. The top of claim 25 wherein the top panel is comprised of a top rear panel and a top front panel, the top front panel being removably attachable to the top rear panel.

27. The top of claim 26 wherein the top front panel overlaps a portion of the top rear panel.

28. The top of claim 26 wherein the top rear panel is removably attached to the top front panel suing a clamp.

29. The top of claim 27 wherein the top front panel comprises a bore having internal threads, and the top rear panel comprises a bore, and wherein a threaded fastener extending through the bore such that when the top panels are aligned, the threaded fastener can be screwed into the bore having the internal threads.

30. The top of claim 25 wherein the bottom edges of the first, second, and rear side panels are removably attachable to the structural portions of the vehicle.

31. A top for an automotive vehicle comprising four separate removably attachable panels including a first side panel, a second side panel, a rear side panel, and a top panel, wherein the first and second side panels are removably attachable to the top panel and the rear panel, and the rear panel is removably attachable to top panel.

32. The top claim 31 wherein the top panel comprises a front top panel and a rear top panel, the top panels removable attachable to each other; and wherein the rear top panel is removably attachable to the side and rear panels

33. The top of claim 31 wherein the panels are stackable.

34. A removable top for an automotive vehicle, the vehicle having a first side structural portion of the vehicle, a second side structural portion of the vehicle, at least one rear side structural portion of the vehicle, and a front structural vehicular member, the removable top comprising:
a first side panel having an upper edge, a lower edge, a front edge, and a rear edge;
a rear panel having an upper edge, a lower edge, a first side edge, and a second side edge; and
a second side panel having an upper edge, a lower edge, a front edge, and a rear edge.
